(19) United States
(12) Patent Application Publication
(10) Pub. No.: US 2005/0200063 A1
(43) Pub. Date: Sep. 15, 2005

(54) Vibration-damping coupling device

(76) Inventors: Jacques Molet, Gohory (FR); Christophe Porpe, Serquigny (FR)

Correspondence Address: MCCRACKEN & FRANK LLP, 200 W. ADAMS STREET, SUITE 2150, CHICAGO, IL, 60606, US

(21) Appl. No.: 11/073,175

(22) Filed: Mar. 3, 2005

(30) Foreign Application Priority Data
Mar. 12, 2004 (FR) FR04 02612

(51) Int. Cl. F16M 1/00

(52) U.S. Cl. 267/153

(57) ABSTRACT

A vibration-damping coupling device for coupling a vibrating structure element to a non-vibrating structure element comprises: an elastomer body provided with two fastening portions each designed to be fastened respectively to one of elements; and a flexible limiter band disposed around the elastomer body and adapted to limit the relative extension movements between the two fastening elements, the limiter band being fastened to the elastomer body at least by clipping. The elastomer body is further provided with an overmolded portion that is molded over the limiter band, the limiter band being foldable over from an extension position in which it is deployed, to an in-use position in which it surrounds the elastomer body.

The invention relates to a vibration-damping coupling device for coupling together two elements that vibrate relative to each other.

### BACKGROUND OF THE INVENTION

More precisely, the invention relates to a vibration-damping coupling device for coupling a vibrating structure element to a non-vibrating structure element, said device comprising:
an elastomer body provided with two fastening portions each designed to be fastened respectiveley to one of said elements; and
a flexible limiter band disposed around the elastomer body and adapted to limit the relative extension movements between the two fastening elements, the limiter band being fastened to the elastomer body at least by clipping.

Current vibration-damping coupling devices such as those described in Document EP 0 816 734 B1 comprise a device of the above-described type having a limiter element that is fastened removably.

In that type of device, the limiter is not fastened to the elastomer body, and therefore might become detached from the elastomer body, giving rise to degradation in the endurance of the elastomer body, or even to said body becoming torn under a traction force that is too large.

### OBJECTS AND SUMMARY OF THE INVENTION

A particular object of the present invention is to mitigate that drawback.

To this end, according to the invention, a vibration-damping device of the type in question is characterized in that the elastomer body is further provided with an overmolded portion that is molded over the limiter band, the limiter band being foldable over from an extension position in which it is deployed, to an in-use position in which it surrounds the elastomer body.

By means of these provisions, the limiter band is non-removable. It is held continuously at the overmolded portion of the elastomer body and there is no risk of it becoming detached from the elastomer body. In addition, this type of device is easy to implement, because it is possible for the band, which is free to pivot or to twist, not to surround the elastomer body during the molding step.

In various embodiments of the device of the invention, it is optionally possible to make use of one or more of the following provisions:
the body is provided with at least two catches between which the limiter band is fastened by clipping;
the overmolded portion and the catches are disposed at opposite ends;
the overmolded portion and the catches are disposed perpendicularly in a plane defined by the band;
the fastening portions of the elastomer body are interconnected by two branches defining a substantially central opening formed in a manner such as to absorb the vibration;
the elastomer body is of oblong shape, extending between two ends, the fastening portions being situated at either end;
the catches are hook-shaped;
the catches are disposed facing each other and are disposed in offset manner;
at one of its ends, the elastomer body has a projecting pad which is molded over the limiter band;
the limiter band is flexible and is folded over by being twisted or pivoted; and
the limiter band is rigid and can be folded over by being pivoted.

The invention also provides a method of manufacturing a vibration-damping device of the invention, which method comprises the following steps:
molding the elastomer body;
overmolding the band in said elastomer body, with the band being in an “extension” position in which it is situated in alignment with the elastomer body, the two steps of molding and of overmolding being performed simultaneously; and
a step in which the band is folded over into an in-use position in which it surrounds the elastomer body.

### BRIEF DESCRIPTION OF DRAWING

Other characteristics and advantages of the invention will appear on reading the following description of embodiments thereof, given by way of non-limiting example, and with reference to the accompanying drawings, in which:

FIG. 1 is a three-dimensional view of a vibration-damping device of the invention, in the in-use position;

FIG. 2 is a view similar to the FIG. 1 view, and in which the limiter band 22 can pivot.

### MORE DETAILED DESCRIPTION

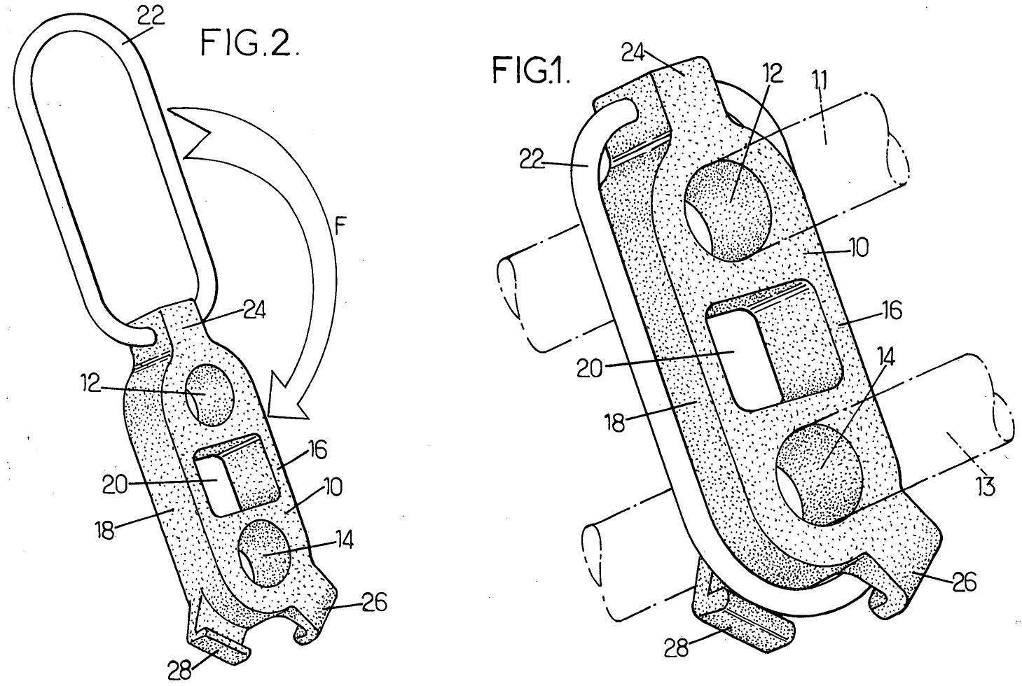

As shown in FIG. 1, the vibration-damping coupling device comprises an elastomer body 10 provided with two fastening portions 12, 14 serving to be fastened respectively to a vibrating structure element 11 and to a non-vibrating structure element 13. For example, the vibrating structure element 11 can be an exhaust pipe of a vehicle, and the non-vibrating element 13 can be the body of the vehicle. The vibration-damping coupling device makes it possible to connect the elements together, while damping the motion of the vibrating element 11 relative to the non-vibrating element 13.

Each of the two fastening portions 12, 14 is formed of a circular opening 20 into which a respective portion of the structure elements 11, 13 is inserted. Said openings 12, 14 are disposed at opposite ends from each other in the direction of movement in the elastomer body 10, and they are interconnected by two parallel branches 16, 18 extending in the direction of movement, and defining a central opening 20 formed so as to absorb the vibration.

As shown in FIG. 1, the body 10 of the device is oblong in shape, and the fastening portions 12, 14 are situated at either longitudinal end of said body 10.

The device further comprises a limiter band 22 that is oblong in shape and that surrounds the elastomer body 10. It is made of rigid material, such as Rayon thread, Kevlar®, metal cable or wire, or rigid plastic.

The limiter band is held by being clipped at one of its longitudinal ends between two catches 26, 28 disposed on the elastomer body 10. As shown in FIG. 1, at its end opposite from the catches, the limiter band 22 is overmolded in a pad 24 projecting from said end of the elastomer body 10. The limiter band is held around the elastomer body between the pad 24 and the catches 26, 28.

The limiter band surrounds the elastomer body with a certain amount of clearance so as to enable the elastomer body to extend while also limiting the extent to which the two structure elements can move relative to each other.

It is mounted to pivot freely about a transverse axis that is substantially perpendicular to the longitudinal axis, the transverse axis being the axis of the hollow cylinder formed in the pad for the purpose of receiving the band 22.

The catches 26, 28 are hook-shaped and are disposed facing each other so as to prevent the band 22 from pivoting, and thus to hold it in an in-use position, in which it surrounds the elastomer body 10. In addition, the catches 26, 28 are disposed in mutually offset manner, and they can deform, in order to make it easier for the limiter band 22 to be clipped therebetween.

In the in-use position, i.e. in the position in which the vibration-damping device is fitted over the structure elements, the band 22 is held between two catches 26, 28 situated on the elastomer body 10 at the end thereof that is opposite from the end on which the pad 24 is provided.

FIG. 2 shows the device of the invention, with the limiter band 22 in the extension position, in which the band 22 is situated in alignment with the elastomer body 10. It is free to pivot about the transverse axis defined by the hollow cylinder provided in the pad 24. In FIG. 2, an arrow F indicates one of the possible ways in which the band 22 can move in order to be engaged between the two catches 26, 28.

The vibration-damping coupling device of the invention is formed in the following manner: the body 10 is formed by molding, and the rigid limiter 22 is overmolded in part at one of the ends of the elastomer body 10, without the limiter band being caused to adhere to the body, so as to enable said band 22 to pivot. These steps are performed simultaneously. During said steps, the band 22 is in the extension position. After molding, said limiter band 22 is folded over and engaged between the two fastening catches 26, 28, and then the vibration-damping device is positioned on the structure elements 14, 13 of the vehicle, between which elements transmission of vibration is to be limited. The device is fastened to the structure elements by means of the fastening portions 12, 14.

In another embodiment, the limiter band 22 is flexible and is made of a material that is less extensible than the material of the elastomer body 10 so as to limit the relative extension movements between the two structure elements 11, 13.

The band can optionally be caused to adhere to the pad 24 on the elastomer body 10, so that it twists as it is folded over from its extension position to its in-use position, between the catches 26, 28. Otherwise, if it is not caused to adhere to said pad, it pivots as it is folded over from its extension position to its in-use position.

The method of forming this type of device comprises the following steps: the elastomer body 10 is molded, then the limiter band 22 is embedded, by overmolding, in said elastomer body 10 in the in-use position, or else in the extension position. The molding and overmolding steps are performed simultaneously. When the device is molded with the band in the extension position, said band is then folded over into the in-use position before the device is put in place on the vehicle.

In a variant of the invention (not shown), the catches and the overmolded portion are disposed perpendicularly, in a plane defined by the band in the in-use position.

The invention is in no way limited to the above-described embodiments, which are given merely by way of indication, and, numerous modifications can easily be made by the person skilled in the art without going beyond the ambit of the invention.

1. A vibration-damping coupling device for coupling a vibrating structure element to a non-vibrating structure element, said device comprising:
an elastomer body provided with two fastening portions each designed to be fastened respectively to one of said elements; and
a flexible limiter band disposed around the elastomer body and adapted to limit the relative extension movements between the two fastening elements, the limiter band being fastened to the elastomer body at least by clipping;
Wherein the elastomer body is further provided with an overmolded portion that is molded over the limiter band, the limiter band being foldable over from an extension position in which it is deployed, to an in-use position in which it surrounds the elastomer body.

2. A device according to claim 1, wherein that the body is provided with at least two catches between which the limiter band is fastened by clipping.

3. A vibration-damping coupling device according to claim 2, wherein that the overmolded portion and the catches are disposed at opposite ends.

4. A vibration-damping coupling device according to claim 2, wherein that the overmolded portion and the catches are disposed perpendicularly in a plane defined by the band in the in-use position.

5. A vibration-damping coupling device according to claim 1, wherein that the fastening portions of the elastomer body are interconnected by two branches defining a substantially central opening formed in a manner such as to absorb the vibration.

6. A vibration-damping coupling device according to claim 1, wherein that the elastomer body is of oblong shape, extending between two ends, the fastening portions being situated at either end.

7. A vibration-damping coupling device according to claim 2, wherein that the catches are hook-shaped.

8. A vibration-damping coupling device according to claim 2, wherein that the catches are disposed facing each other and are disposed in offset manner.

9. A vibration-damping coupling device according to claim 1, wherein that, at one of its ends, the elastomer body has a projecting pad which is molded over the limiter band.

10. A vibration-damping coupling device according to claim 1, wherein that the limiter band is flexible and is folded over by being twisted or pivoted.

11. A vibration-damping coupling device according to claim 1, in which the limiter band is rigid and can be folded over by being pivoted.

12. A method of manufacturing a vibration-damping device according to claim 1, wherein that it comprises the following steps:
molding the elastomer body;
overmolding the band in said elastomer body, with the band being in an “open” position in which it is situated in alignment with the elastomer body, the two steps of molding and of overmolding being performed simultaneously; and
a step in which the band is folded over into an in-use position in which it surrounds the elastomer body.

13. A method of manufacturing a vibration-damping device according to claim 10, wherein that it comprises the following steps:
molding the elastomer body;
overmolding the limiter band in said elastomer body, with the band being in the in-use position, the two steps of molding and of overmolding being performed simultaneously.
